(19) United States
(12) Patent Application Publication
(10) Pub. No.: US 2021/0395410 A1
(43) Pub. Date: Dec. 23, 2021

(54) POLYOLEFIN TERPOLYMERS, VITRIMERS MADE THEREFROM, AND METHOD OF MAKING THE POLYOLEFIN TERPOLYMERS AND VITRIMERS

(71) Applicant: SABIC Global Technologies B.V., Bergen op Zoom (NL)

(72) Inventors: Jérôme VACHON, Geleen (NL); Jonathan TELLERS, Parma (IT); Peter NEUTEBOOM, Geleen (NL); Maria SOLIMAN, Geleen (NL); Roberta PINALLI, Parma (IT); Enrico DALCANALE, Parma (IT)

(73) Assignee: SABIC Global Technologies B.V., Bergen op Zoom (NL)

(21) Appl. No.: 17/292,515

(22) PCT Filed: Dec. 3, 2019
(86) PCT No.: PCT/IB2019/060412

§ 371 Date: May 10, 2021

Related U.S. Application Data
(60) Provisional application No. 62/774,995, filed on Dec. 4, 2018.

(51) Int. Cl. C08F 210/02

(52) U.S. Cl. CPC C08F 210/02; C08F 2810/50; C08F 2810/20; C08F 2800/10

(57) ABSTRACT

Terpolymers that include a hydrocarbon unit, an acetoacetate terminated unit and a hydroxy-terminated unit are described. Vitrimers made from these terpolymers are also described.

### CROSS REFERENCE TO RELATED APPLICATIONS

This application claims priority to U.S. Provisional Application No. 62/774,995 filed Dec. 4, 2018 whose contents are incorporated by reference in its entirety without disclaimer.

### GOVERNMENT STATEMENT

The invention was made with support from the European Union's Horizon 2020 research and innovation program under the Marie Sklodowska-Curie grant agreement No 642929.

### BACKGROUND OF THE INVENTION

### A. Field of the Invention

The invention generally concerns a terpolymer that includes a hydrocarbon polymer unit coupled to an acetoacetate-terminated polymer unit and a hydroxy-terminated ester unit and vitrimers made from the terpolymer.

### B. Description of Related Art

Vitrimers are an emerging class of polymers that have properties of permanently cross-linked thermosets while at the same time retaining processability due to covalently adaptable cross-links (CAN). CAN, when thermally triggered, can undergo exchange reactions of cross-links, which facilitate polymer network rearrangement, making macroscopic reshaping possible. If a stress is applied to the system, the cross-links can rearrange until the stress relaxes and a new shape is obtained. The relaxation process can be controlled by the reaction kinetics, and, consequently, the viscosity in the melt decreases following the Arrhenius law. This characteristic is distinctly different from conventional polymers such as polystyrene, which exhibits a viscosity drop abruptly after reaching its glass transition (Tg).

Various attempts to produce vitrimers have been described. By way of example, Denissen et al. (Advanced Functional Materials, 2015, Vol. 25, pp. 2451-2457 and Nature communications, 2017, Vol. 8, p. 14857) described catalyst free vitrimers that include vinylogous urethane cross-links. In another example, Zhou et al. (Macromolecules, 2017, Vol. 50, pp. 6742-6751) and Demongeot et al. (Macromolecules 2017, Vol. 50, pp. 6117-6127) describe reactive extrusion of poly(butylene terephthalate) to prepare semi-crystalline polymer vitrimers. In yet another example, de Luzuriaga et al. (Journal of Materials Chemistry C, 2016, Vol. 4, pp, 6220-6223) and Azcune et al. (European Polymer Journal, 2016, pp. 147-160) describe epoxide type vitrimers. In still another example, U.S. Patent Application Publication No. 2017327625 to Du Prez et al. describes vitrimers that include urethane cross-link functionality.

While processes to prepare vitrimers have been described, many of them require catalysts and/or the resulting vitrimer is susceptible to hydrolysis and aging. There is therefore a need to develop stable vitrimer materials in a more cost efficient manner.

### SUMMARY OF THE INVENTION

A discovery has been made that address at least some of the problems associated with producing polymers and their subsequent conversion into vitrimers. The solution is premised on producing a terpolymer that includes a polymeric matrix having random distribution of a hydrocarbon unit, an acetoacetate terminated unit and a hydroxy-terminated unit in the polymeric matrix. The units can be monomeric units, oligomeric units and/or polymeric units randomly distributed throughout the terpolymer matrix. The acetoacetate functionality of the acetoacetate terminated unit can be reacted with a suitable cross-linking agent (e.g., polyamines) to produce a vitrimer. Furthermore, a facile method for the preparation of semi-crystalline vitrimer materials starting from functionalized polyolefins and commercially available di-, tri-, or multifunctional amines is provided. These starting materials can be co-polymers of ethylene with acetoacetate-functionalized (meth)acrylate. Notably, the vitrimer material of the present invention is recyclable.

In one aspect of the present invention, random terpolymers useful for producing semi-crystalline vitrimers are described. A random terpolymer can include a non-uniform distribution (e.g., random) of a hydrocarbon unit (e.g., a C₂₋₅ hydrocarbon unit), an acetoacetate (ACAC) terminated unit and a hydroxy-terminated ester unit, or combinations thereof in the polymeric matrix. The hydrocarbon unit (A) can have the formula

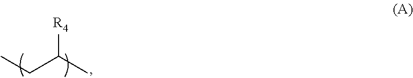

the acetoacetate (ACAC) terminated unit (B) can have the formula

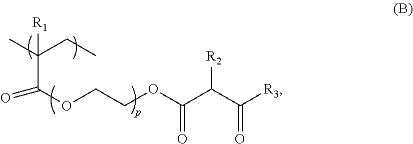

the hydroxy terminated ester unit (C) can have the formula

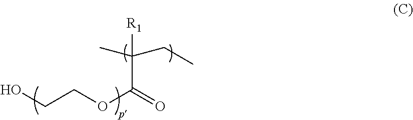

where R₁ and R₂ are each independently hydrogen (H) or a C₁₋₅ alkyl group, R₃ is a C₁₋₁₀ alkyl group, R₄ is a H or a C₁₋₅ alkyl group, p is 1 to 9, and p′ is 1 to 9 and where the hydrocarbon unit (A), the ACAC terminated unit (B), and the hydroxy terminated ester unit (C) are comprised in the random terpolymer. In some instances, the terpolymer consists of, or consists essentially of units A, B, C coupled together in a non-uniform distribution.

In some instances, the random terpolymer matrix can include, but is not limited to, a terpolymer represented by the formula:

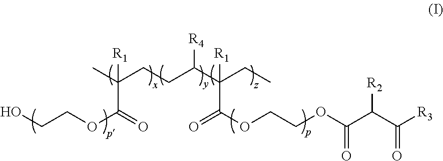

where R₁ and R₂ can each independently hydrogen (H) or a C₁₋₅ alkyl group, R₃ can be H or a C₂₋₁₀ alkyl group, R₄ is a H or a C₁₋₅ alkyl group, p can be 1 to 9, p′ can be 1 to 9, x can be 0 to 10, y can be 88 to 99, and z can be 0.1 to 10, where p and p′ are repeat units and x, y, z are mole percentage (mol. %) of functional group content. In some embodiments, R₁ and R₂ in structures A, B, C and (I) can each be independently hydrogen (H) or methyl (CH₃). The random terpolymer can include less than 10 mol. % of the acetoacetate terminated unit, more preferably less than 1 mol. %, more preferably 0.6 to 1 mol. %. In some instances, the terpolymer is the reaction product of a C₂₋₅ olefin, hydroxyl-ethyl (meth)acrylate, and 2-(methacryloyloxy) ethyl acetoacetate. The random terpolymer of the present invention can be insoluble in water.

In another aspect of the present invention, processes to make the random terpolymer materials of the present invention are described. A process can include a high-pressure free radical process that can include contacting a reactant mixture that can include a C₂₋₅ olefin monomer (e.g., a monomer of hydrocarbon unit A) and an acetoacetate monomer (e.g., monomer or oligomer of ACAC unit B) with a polymerization initiator at a temperature of 100° C. to 350° C., preferably 150° C. to 310° C. and a pressure of 180 MPa to 350 MPa, preferably 200 MPa to 300 MPa. The concentration of the acetoacetate monomer in the reactant mixture can be less than 10 mol. %, preferably less than 1 mol. %, more preferably 0.1 mol. % to 0.5 mol. %. In another instance, a hydroxy-terminated acrylate monomer, which is a precursor to hydroxy-terminated acrylate unit C, can be added to the reaction mixture and the hydroxy-terminated acrylate monomer can react with C₂₋₅ olefin monomer and the acetoacetate monomer in a random manner to produce the random terpolymer of the present invention. The process can be performed in a continuous manner.

In yet another aspect of the present invention vitrimer materials that include the terpolymer of the present invention are described. A vitrimer can include at least two polymeric units (D, D′) and a linking moiety (L), having the formula D-L-D. The polymeric unit D, D′, or both can include a terpolymer having a random distribution of a hydrocarbon unit (A) having the formula

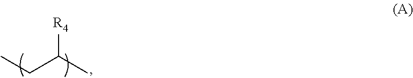

an acetoacetate (ACAC) terminated unit (B) having the formula

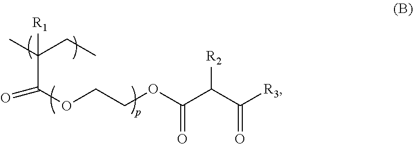

and a hydroxy terminated ester unit (C) having the formula

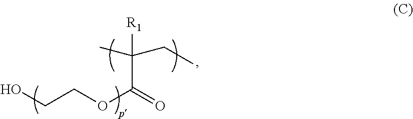

where R₁ and R₂ are each independently hydrogen (H) or a C₁₋₅ alkyl group, R₃ is a C₁₋₁₀ alkyl group, R₄ is a H or a C₁₋₅ alkyl group, p is 1 to 9, and p′ is 1 to 9 are repeating units. In some instances, D, D′ or both can include a terpolymer unit having the following formula:

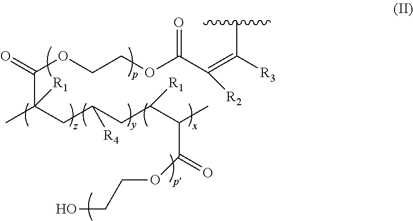

where R₁ and R₂ can each be independently hydrogen (H) or a C₁₋₅ alkyl group, R₃ can be H or a C₁₋₁₀ alkyl group, R₄ is a H or a C₁₋₅ alkyl group, p can be 1 to 9, and p′ can be 1 to 9, x can be 0 to 10, y can be 88 to 99, and z can be 0.1 to 10, where p and p′ are repeating units and x, y, z are mole percentage (mol. %) of functional group content. In the structure the wavy line indicates the bond to the linker group (L). The polymeric unit D, D′ or both can be derived from the terpolymer of present invention. In a preferred instance, D and D′ are both terpolymers of the present invention. L can be a polyamino group that includes at least two secondary amines. Non-limiting examples of polyamino group can include:

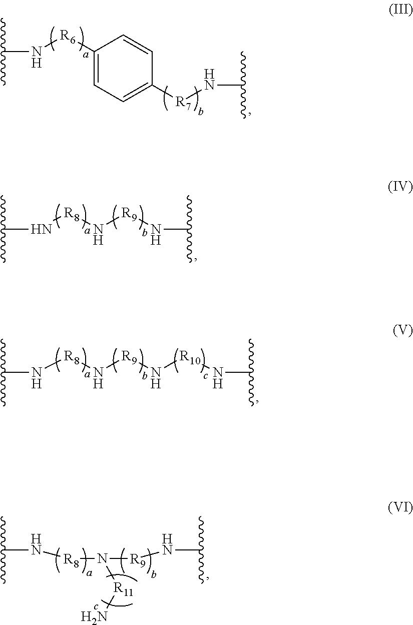

or any combination thereof,
where R₆ and R₇ are each independently an aliphatic group, and R₈, R₉, R₁₀, and R₁₁ are each independently an aliphatic group, or an aromatic group, and a is 1 to 20, b is 1 to 20 and c is 1 to 20. In a preferred embodiment, L is p-xylene diamine. The vitrimer material can be semi-crystalline, recyclable, or both

In another aspect of the present invention, processes of producing a vitrimer material(s) of the present invention are described. A process can include contacting a reactant mixture that includes the random terpolymer of the present invention with a polyamino group at temperatures from 120° C. to 300° C., preferably 140° C. to 160° C.

It is also contemplated in the context of the present invention that the vitrimer materials can be used to produce sheets, films, and/or foams. The vitrimer materials can be used alone or in combination with other polymer material (e.g., blends) to produce such sheets, films, and/or foams.

In the context of the present invention, 20 embodiments are described. Embodiment 1 is a random terpolymer comprising a random distribution of a hydrocarbon unit, an acetoacetate (ACAC) terminated unit, and a hydroxy terminated unit. Embodiment 2 is the random terpolymer of embodiment 1, wherein the random terpolymer comprises a terpolymer having the formula of:

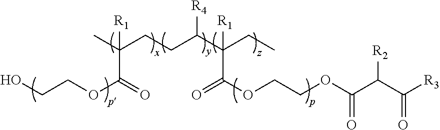

where R₁ and R₂ are each independently hydrogen (H) or a C₁₋₅ alkyl group, R₃ is a C₁₋₁₀ alkyl group, R₄ is a H or a C₁₋₅ alkyl group, p is 1 to 9, p′ is 1 to 9, x is 0 to 10, y is 88 to 99, and z is 0.1 to 0.10, where p and p′ are repeating units and x, y and z are mole % of functional group content. Embodiment 3 is the random terpolymer of embodiment 2, wherein R₁ and R₂ are each independently hydrogen (H) or methyl (CH₃). Embodiment 4 is the random terpolymer of any one of embodiments 1 to 3, wherein the terpolymer includes less than 10 mol. % of the acetoacetate functionality, more preferably less than 1 mol. %, more preferably 0.6 to 1 mol. %. Embodiment 5 is the terpolymer of any one of embodiments 1 to 4, wherein the hydrocarbon polymer chain is the reaction product of an olefin, preferably C₂₋₅ olefins, more preferably ethylene, a hydroxyl-ethyl (meth)acrylate, and 2-(methacryloyloxy) ethyl acetoacetate. Embodiment 6 is the terpolymer of any one of embodiments 1 to 5, wherein the polymeric material is insoluble in water.

Embodiment 7 is a high-pressure free radical process to produce the terpolymer of any one of embodiments 1 to 6, the process comprising contacting a reactant mixture comprising a C₂₋₅ olefin monomer and an acetoacetate monomer with a polymerization initiator at a temperature of 100° C. to 350° C., preferably 150° C. to 310° C., and a pressure of 180 MPa to 350 MPa, preferably 200 MPa to 300 MPa, to produce the polymeric material of any one of embodiments 1 to 5. Embodiment 8 is the process of embodiment 7, wherein concentration of the acetoacetate monomer in the reactant mixture is less than 10 mol. %, preferably less than 1 mol. %, more preferably 0.1 mol. % to 0.5 mol. %. Embodiment 9 is the process of any one of embodiments 7 to 8, wherein contact of the C₂₋₅ olefin monomer and the acetoacetate monomer with the polymerization initiator can produce in part a hydroxy-terminated material in situ. Embodiment 10 is the process of any one of embodiments 7 to 8, further comprising providing a hydroxy-terminated material to the reaction mixture, and reacting the hydroxy-terminated material with C₂₋₅ olefin monomer and the acetoacetate monomer. Embodiment 11 is the process of embodiment 10, wherein the hydroxy-terminated material is hydroxyl-ethyl methacrylate. Embodiment 12 is the process of any one of embodiments 7 to 11, wherein the C₂₋₅ olefin monomer is ethylene, the acetoacetate monomer is 2-(methacryloyloxy)ethyl acetoacetate, and the polymerization initiator is a peroxide material. Embodiment 13 is the process of any one of embodiments 7 to 12, wherein the process is a continuous process.

Embodiment 14 is a vitrimer material comprising at least two polymeric units (D) and a linking moiety (L) having the formula D-L-D, wherein the polymeric unit (D) has the following formula:

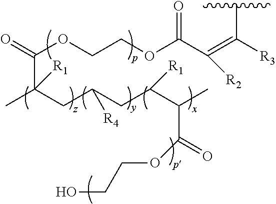

where R₁ and R₂ are each independently hydrogen (H) or a C₁₋₅ alkyl group, R₃ is H or a C₁₋₁₀ alkyl group, R₄ is a H or a C₁₋₅ alkyl group, p is 1 to 9, and p′ is 1 to 9, x is 0 to 10, y is 88 to 99, and z is 0.1 to 10, where p and p′ are repeat units and x, y, z are mole percentages of functional group content. Embodiment 15 is the vitrimer material of embodiment 14, wherein L is a polyamino group comprising at least two secondary amines. Embodiment 16 is the vitrimer material of embodiment 15, wherein the polyamino group is

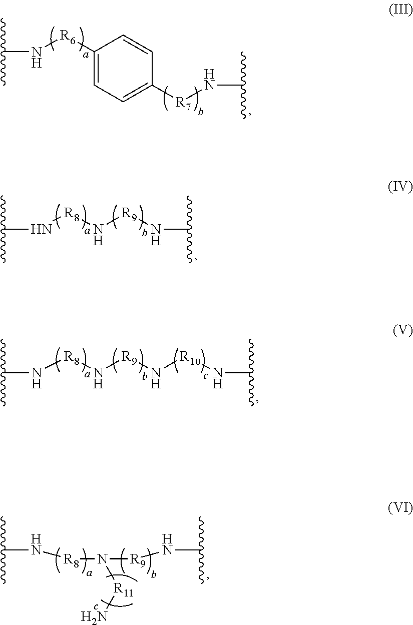

or any combination thereof,
where R₆ and R₇ are each independently an aliphatic group, and R₈, R₉, R₁₀, and R₁₁ are each independently an aliphatic group, or an aromatic group, and a is 1 to 20, b is 1 to 20, and c is 1 to 20. Embodiment 17 is the vitrimer material of any one of embodiments 14 to 16, wherein the polymeric unit A is derived from the terpolymer of any one of embodiments 1 to 6. Embodiment 18 is the vitrimer material of any one of embodiments 14 to 17, wherein the vitrimer comprises a semi-crystalline morphology and/or the vitrimer is recyclable. Embodiment 19 is a process of producing a vitrimer material of any one of embodiments 14 to 18 using an extruder, the process comprising contacting a reactant mixture comprising a terpolymer of any one of embodiments 1-6 with the polyamino group of embodiment 14 or 15 at temperatures from 120° C. to 300° C., preferably 140° C. to 160° C. Embodiment 20 is an article of manufacture comprising the terpolymer of any one of embodiments 1 to 6 or the vitrimer of any one of embodiments 14 to 18.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

An aliphatic group is an acyclic or cyclic, saturated or unsaturated carbon group, excluding aromatic compounds. A linear aliphatic group does not include tertiary or quaternary carbons. Non-limiting examples of aliphatic group substituents include halogen, hydroxyl, alkoxy, haloalkyl, haloalkoxy, carboxylic acid, ester, amine, amide, nitrile, acyl, thiol and thioether. A branched aliphatic group includes at least one tertiary and/or quaternary carbon. Non-limiting examples of branched aliphatic group substituents include alkyl, halogen, hydroxyl, alkoxy, haloalkyl, haloalkoxy, carboxylic acid, ester, amine, amide, nitrile, acyl, thiol and thioether. A cyclic aliphatic group is includes at least one ring in its structure. Polycyclic aliphatic groups may include fused, e.g., decalin, and/or spiro, e.g., spiro[5.5]undecane, polycyclic groups. Non-limiting examples of cyclic aliphatic group substituents include alkyl, halogen, hydroxyl, alkoxy, haloalkyl, haloalkoxy, carboxylic acid, ester, amine, amide, nitrile, acyl, thiol and thioether.

An alkyl group is linear or branched, substituted or unsubstituted, saturated hydrocarbon. Non-limiting examples of alkyl group substituents include alkyl, halogen, hydroxyl, alkoxy, haloalkyl, haloalkoxy, carboxylic acid, ester, amine, amide, nitrile, acyl, thiol and thioether. “Alkenyl” and “alkenylene” mean a monovalent or divalent, respectively, straight or branched chain hydrocarbon group having at least one carbon-carbon double bond (e.g., ethenyl (—HC═CH₂). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclizations.

An “aromatic” group is a substituted or unsubstituted, mono- or polycyclic hydrocarbon with alternating single and double bonds within each ring structure. Non-limiting examples of aryl group substituents include alkyl, halogen, hydroxyl, alkoxy, haloalkyl, haloalkoxy, carboxylic acid, ester, amine, amide, nitrile, acyl, thiol and thioether. Arylalkylene” means an alkylene group substituted with an aryl group (e.g., benzyl). The prefix “halo” means a group or compound including one or more halogen (F, Cl, Br, or I) substituents, which can be the same or different. The prefix “hetero” means a group or compound that includes at least one ring member that is a heteroatom (e.g., 1, 2, or 3 heteroatoms), wherein each heteroatom is independently N, O, S, or P. Aromatic groups include “heteroaryl” group or a “heteroaromatic” group, which is a mono- or polycyclic hydrocarbon with alternating single and double bonds within each ring structure, and at least one atom within at least one ring is not carbon. Non-limiting examples of heteroaryl group substituents include alkyl, halogen, hydroxyl, alkoxy, haloalkyl, haloalkoxy, carboxylic acid, ester, amine, amide, nitrile, acyl, thiol and thioether.

“Substituted” means that the compound or group is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g., toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the designated number of carbon atoms excluding the substituents.

The phrase “mechanical constraint” refers to the application of a mechanical force, locally or to all or part of the article such that the article's shape is transformed (e.g., deformed or formed). Non-limiting examples of mechanical constraints include pressure, molding, blending, extrusion, blow-molding, injection-molding, stamping, twisting, flexing, pulling and shearing.

The term “random” refers to an arbitrary distribution of units A, B, and C in the polymeric matrix. For example, the non-limiting distribution of monomeric units A, B and C can be -A-B-C-, -A-C-B-, -B-A-C-, -A-A-B-, -A-A-C-, -B-B-A-, -C-C-A-, -C-C-B- and the like.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The terpolymers or vitrimers that include the terpolymers of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the terpolymers of the present invention are their abilities to be extruded into semi-crystalline vitrimer materials.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 shows high temperature proton nuclear magnetic resonance (HT-¹H NMR) for the PACE polymers and a comparison example made through transesterification.

FIG. 2 shows dynamic mechanical thermal analysis (DMTA) graphs for PACHE copolymer with varying ACAC content cross-linked with 0.55 molar equivalents of p-xylylene diamine (with respect to ACAC groups). The curves are named according to the ACAC content of the parent polymer.

FIG. 3 shows graphs of frequency sweep at 160° C. of PACHE copolymers with varying ACAC contents cross-linked with 0.55 molar equivalents of p-xylylene diamine (with respect to ACAC groups) and a pristine sample (no crosslinking). The curves are named according to the ACAC content of the parent polymer.

FIG. 4 shows graphs of complex viscosity of vitrimers of the present invention and a pristine sample (no crosslinking) as function of frequency measured in the melt at 160° C.

FIG. 5 shows average results (from quadruplets) of tensile tests on dog bones made from vitrimers (PACHE with 0.94% ACAC and 0.55 equivalents of XYDIA, Break 1) and recycled dog bones made from the tested dog bones processed 2, 3 and 4 times (Breaks 2, 3, and 4).

While the invention is susceptible to various modifications and alternative forms, specific embodiments thereof are shown by way of example in the drawings. The drawings may not be to scale.

### DETAILED DESCRIPTION OF THE INVENTION

A discovery has been made that provides a solution to at least some of the problems associated with production of vitrimers. The discovery is premised on the idea of a terpolymer that is capable of being extruded in the presence of a crosslinking group at temperatures of 120° C. to 300° C. to produce a vitrimer material. The produced vitrimer material can be semi-crystalline. The terpolymer used to produce the vitrimer material can be a random terpolymer. The random terpolymer can include a hydrocarbon unit, an acetoacetate-terminated unit and a hydroxy-terminated unit (e.g., units A, B and C described above) randomly distributed in the polymeric matrix. Notably, the terpolymer can be water insoluble.

These and other non-limiting aspects of the present invention are discussed in further detail in the following sections.

A. Functionalized Polymers

The functionalized polymers of the present invention can include a terpolymer or a copolymer. The terpolymers of the present invention are functionalized polymers. Terpolymers of the present invention can be the random reaction products of an olefin (e.g., C₁₋₅ olefin, preferably, ethylene or propylene), an acetoacetate terminated (meth)acrylate (ACAC), and a hydroxyl terminated (meth)acrylate (HEMA) forming a random terpolymer having non-uniformly distributed units (e.g., containing a PE-ACAC-HEMA or PACHE portion) in the polymeric matrix. The random terpolymer can a random distribution of 3 units coupled together in a non-uniform manner. The three units include a hydrocarbon unit (A) having the formula

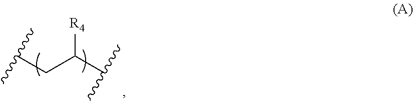

an acetoacetate (ACAC) terminated unit (B) having the formula

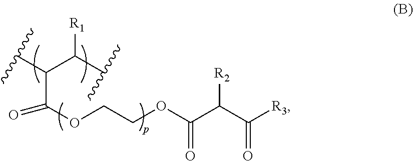

and a hydroxy terminated ester unit (C) having the formula

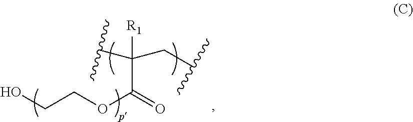

where R₁ and R₂ are each independently hydrogen (H) or a C₁₋₅ alkyl group, R₃ is a C₁₋₁₀ alkyl group, R₄ is a H or a C₁₋₅ alkyl group, p is 1 to 9, and p′ is 1 to 9. Units A, B and C, can be coupled in a random manner at the wavy lines. For example, A can couple to B and/or C, two B units can couple and then couple to an A unit or a C unit, two C units can couple and then couple to an A unit or a B unit, and so on.

A portion of the random terpolymer can also be represented by the formula:

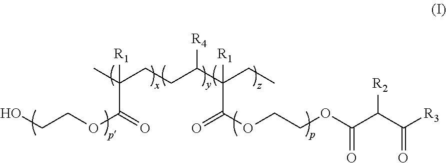

where R₁ and R₂ can each be independently hydrogen (H) or a C₁₋₅ alkyl group, R₃ can be a H or C₁₋₁₀ alkyl group, R₄ can be a H or a C₁₋₅ alkyl group, p and p′ are repeating units, and x, y and z are mole percentages of the functional group content. Non-limiting examples of C₁₋₅ alkyl groups can include methyl, ethyl, n-propyl isopropyl, n-butyl, sec-butyl, tert-butyl, n-pentyl, and any combination thereof. Non-limiting examples of C₁₋₁₀ alkyl groups can include methyl, ethyl, n-propyl isopropyl, n-butyl, sec-butyl, tert-butyl, n-pentyl, 2-methylbutan-2-yl, 2,2-dimethylpropyl, 3-methylbutyl, pentan-2-yl, pentan-3-yl, 3-methylbutan-2-yl, 2-methylbutyl, hexyl, heptyl, octyl, nonyl, and decyl. The value for p and/or p′ can be 0 to 9, or 1 to 5 or at least any one of, equal to any one of, or between any two of 1, 2, 3, 4, 5, 6, 7, 8, 9, preferably 1. The value for x can be 0 to 10, or at least any one of, equal to any one of, or between any two of 0, 0.1, 1, 2, 3, 4, 5, 6, 7, 8, 9, and 10. The value for y can be 88 to 99, or at least any one of, equal to any one of, or between any two of 88, 89, 90, 91, 92, 93, 94, 95, 96, 97, 98, and 99. The value for z can be 0.1 to 10, or at least any one of, equal to any one of, or between any two of 0.1, 1, 2, 3, 4, 5, 6, 7, 8, 9, and 10. In one embodiment, R₁, R₂ and R₃ are all methyl and R₄ is hydrogen. In another embodiment, R₁ is methyl, and R₂ R₃, and R₄ are hydrogen. In some embodiments, R₁ and R₄ are hydrogen and R₂ and R₃ are methyl. The terpolymers of the present invention can be water insoluble. Without wishing to be bound by theory, the water insolubility is believed to be due to the length of the carbon hydroxyl-terminated chain (i.e., 9 or less chain units) in the terpolymer. This can result in the terpolymers having more hydrophobic or lipophilic characteristics.

The functionalized random terpolymers of the present invention can be made through a high-pressure free radical process. In a preferred aspect, the high pressure free radical process is a continuous process. In the process, suitable monomers can be polymerized under conditions to produce the functionalized terpolymers of the present invention. By way of example, a C₂₋₅ olefin monomer (e.g., a precursor material to the hydrocarbon unit A) and an acetoacetate monomer (e.g., a precursor material to ACAC terminated unit B) and an optional hydroxy-terminated monomer can be contacted with a polymerization initiator at polymerization conditions suitable to produce a functionalized terpolymer of the present invention. Suitable hydrocarbon unit precursor materials can include C₂₋₅ olefinic monomers such as ethylene, propylene, butylene, or pentene, or mixtures thereof. The flow of the reactants can be adjusted to control the degree of polymerization. Polymerization conditions can include temperature and pressures. Reaction temperatures can be at least any one of, equal to one of, or between any two of 100° C., 125° C., 150° C., 175° C., 200° C., 225° C., 250° C., 275° C., 300° C., 325° C. and 350° C. Reaction pressures can be at least any one of, equal to any one of, or between any two of 180 MPa, 190 MPa, 200 MPa, 210 MPa, 220 MPa, 230 MPa, 240 MPa, 250 MPa, 260 MPa, 270 MPa, 280 MPa, 290 MPa, 300 MPa, 310 MPa, 320 MPa, 330 MPa, 340 MPa and 350 MPa. Any peroxide polymer initiator can be used and is available from commercial vendors such as Arkema (France). Non-limiting examples of peroxide initiators include diacyl peroxide, t-butyl peroxypivalate or the like.

Suitable acetoacetate monomers can include any functionalized diketone material or meth(acrylate) having one or more acetoacetate groups, or ethylenically unsaturated monomers having one or more acetoacetate groups. Non-limiting examples of suitable acetoacetate monomers include 2-(methacryloyloxy)ethyl acetoacetate (AAEM) (CAS No. 21282-97-3), 2-(acryloyloxy)ethyl acetoacetate (CAS No. 21282-96-2). In a preferred instance, 2-(methacryloyloxy)ethyl acetoacetate is used. The acetoacetate monomer concentration in the reactant mixture can be less than 10 mol. %, equal to any one of, or between any two of 9.99 mol. %, 8 mol. %, 7 mol. %, 6 mol. %, 5 mol. %, 4 mol. %, 3 mol. %, 2 mol. %, 1 mol. %, 0.9 mol. %, 0.8 mol. %, 0.7 mol. %, 0.6 mol % or 0.5 mol. %, 0.4 mol. %, 0.3 mol. %, 0.2 mol %, 0.1 mol %, but greater than 0 mol. %. In some instances, the acetoacetate monomer concentration is between 0.1 mol. % to 0.5 mol. %.

In some embodiments, contact of the C₂₋₅ olefin monomer (e.g., a hydrocarbon unit precursor material) and the acetoacetate monomer with the polymerization initiator produces a hydroxy-terminated acrylate monomer in situ, and the hydroxy-terminated acrylate monomer can react with at least a portion of the polyolefin backbone to form the terpolymer of the present invention. The hydroxy-terminated acrylate monomer is a precursor to the hydroxy-terminated acrylate unit C. By way of example, ethylene and 2-(methacryloyloxy)ethyl acetoacetate can react to form hydroxyethyl methacrylate, which in turn reacts with a portion of the olefin to form the terpolymer(s) of the present invention.

In another instance, a hydroxy-terminated acrylate monomer (e.g., 2-hydroxyethyl methacrylate) can be added to the reaction mixture that includes the C₂₋₅ olefin monomer and the acetoacetate monomer with the polymerization initiator. At the reaction conditions, the C₂₋₅ olefin monomer, the acetoacetate monomer, and the hydroxy-terminated acrylate monomer react to form the terpolymer(s) of the present invention.

B. Vitrimers

At least two polymeric units (D) of the present invention can be linked with a linking moiety (L) to form a vitrimer of the formula D-L-D′. The polymeric units D and/or D′ can be any one of the random terpolymers of the present invention. In a preferred instance D and D′ are the terpolymers of the present invention. In some instances, D and/or D′ can be a terpolymer having a random distribution of a hydrocarbon unit (A) having the formula

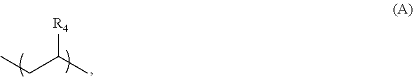

an acetoacetate (ACAC) terminated unit (B) having the formula

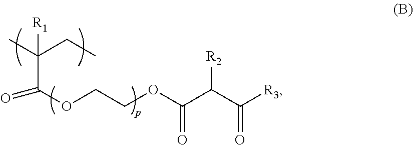

and a hydroxy terminated unit (C) having the formula

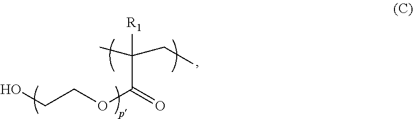

where R₁ and R₂ are each independently hydrogen (H) or a C₁₋₅ alkyl group, R₃ is a C₁₋₁₀ alkyl group, R₄ is a H or a C₁₋₅ alkyl group, p is 1 to 9, and p′ is 1 to 9.

In another instance, a portion of the random terpolymer can have the following formula:

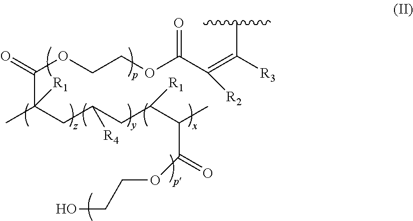

where R₁ and R₂ can each be independently hydrogen (H) or a C₁₋₅ alkyl group, R₃ can be a H or a C₁₋₁₀ alkyl group, R₄ can be a H or a C₁₋₅ alkyl group, p can be 1 to 9, and p′ can be 1 to 9, x can be 0 to 10, y can be 88 to 99, and z can be 0.1 to 10, where p and p′ are repeat units and x, y, z are mole percentage (mol. %) of functional group content. In one instance, the vitrimer can have the following formula:

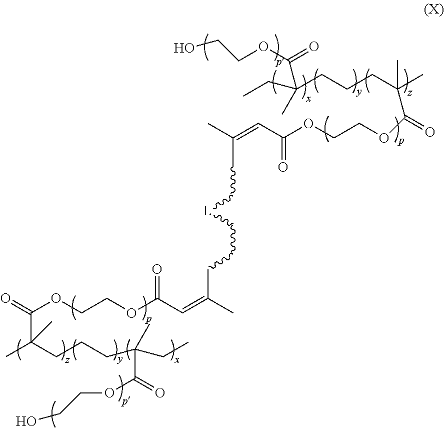

where L is the linking group covalently bonded to the vinyl group of the polymer.

The linking group (L) can be any difunctional group capable of reacting with a carbonyl functional group. In a preferred instance, the linking group is a polyamino group. Polyamino groups can be derived from a di-, tri-, or poly-amine. In some embodiments, polyamines can include amines having the formula (R₅)ₙ—NHₓ, in which R₅ can be optionally substituted C₁₋₂₀ alkyl, C₃₋₈ cycloalkyl, C₆₋₁₂ aryl, hetero C₁₋₂₀ alkyl, heterocycle, heteroaryl, n is 0 to 3, and x is 0 to 2. Non-limiting examples of polyamines include tris(2-aminoethyl)amine, ethylenediamine, tetramethylenediamine, pentamethylenediamine, hexamethylenediamine, diethylenetriamine, triethylenetetramine, tetraethylenepentamine, dihexylenetriamine, cadaverine, putrescine, hexanediamine, spermine, isophorone diamine, dimerized fatty diamine (such as are available commercially under the trade name Priamine from Croda International and the trade name Versamine from Cognis Corporation), 1,3-cyclohexanebis(methylamine), 1,2-diaminocyclohexane, 1,5-diamino-2-methylpentane, 4,9-dioxa-1,12-dodecanediamine, 1,3-pentanediamine, 2,2-dimethyl-1,3-propanediamine, 2,2′-(ethylenedioxy)bis(ethylamine), tris(2-aminoethyl)amine, tris(2-aminoalkyl)amines, 4,4′-methylenebis(cyclohexylamine); 4,7,10-trioxa-1,13-tridecanediamine; all polyether amines (e.g., JEFFAMINE® products commercially available from Huntsman). Non-limiting examples of aromatic amines include m-xylylene diamine, p-xylylene diamine, phenylenediamine, diaminodiphenylmethane, diaminodiphenyl sulfone, methylenebischlorodiethylaniline, or any combination thereof. In some instances p-xylylene diamine, tris(2-aminoalkyl)amines, spermines or any combination thereof can be used. Generic polyamines are illustrated below:

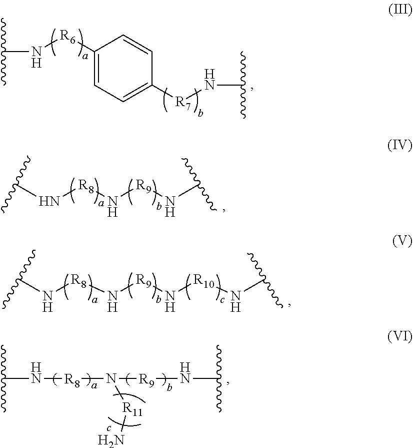

or any combination thereof,
where R₆ and R₇ are each independently an aliphatic group, and R₈, R₉, R₁₀, and R₁₁ are each independently an aliphatic group, or an aromatic group, and a is 1 to 20, b is 1 to 20 and c is 1 to 20. In some embodiments, R₆, R₇, R₈, R₉, R₁₀, and R₁₁ are —CH₂— and can be presented in the following illustration:

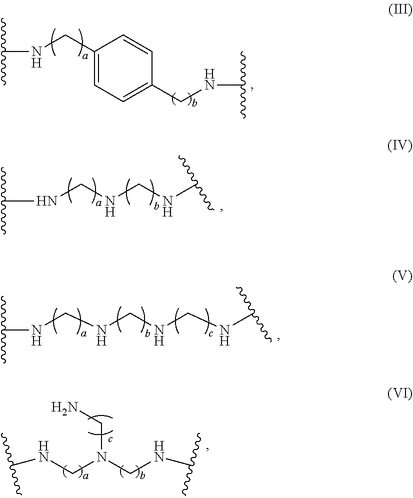

or any combination thereof,
where a is 1 to 20, b is 1 to 20 and c is 1 to 20. In a preferred instance, the polyamine is p-xylene diamine.

Vitrimers of the present invention can be produced through a condensation reaction of the linking group with the functionalized polyolefin. The vitrimers can be manufactured by various methods known in the art. By way of example, the vitrimers can be produced using an extrusion process. The functionalized polymer (e.g., terpolymer) can be contacted with an amount of linking material (e.g., a polyamine) under conditions sufficient to react the linking material with the carbonyl group to form the vitrimer (e.g., a urethane linkage). In some instances, the functionalized polymer and linking material can be blended in a high speed mixer or by hand mixing. The blend can then be fed into the throat of a twin-screw extruder via a hopper. Alternatively, the linking material can be contacted with the functionalize polymer by feeding it directly into the extruder at the throat or downstream through a side port into the extruder. The extruder is generally operated at a temperature higher than that necessary to cause the functionalized polyolefin to flow and sufficient to promote the condensation reaction. Reaction conditions can include temperatures from 120° C. to 300° C., preferably 140° C. to 160° C., or at least any one of, equal to any one of, or between any two of 120° C., 130° C., 140° C., 150° C., 160° C., 170° C., 180° C., 190° C., 200° C., 210° C., 220° C., 230° C., 240° C., 250° C., 260° C., 270° C., 280° C., 290° C. and 300° C. At least a slight excess of linking material amount is used during an extrusion process. The extrudates can be immediately quenched in a water bath and pelletized. Such pellets can be used for subsequent molding, shaping, or forming. A non-limiting example of preparation of vinylogous urethane polyolefin vitrimers with a polyamine is shown in the following reaction scheme (A), where x, y and z are defined above and R₅ is the hydrocarbon moiety (linking group) derived from the polyamine (R₅)ₙNHₓ defined above. The asterisk represent continuing polymeric portions.

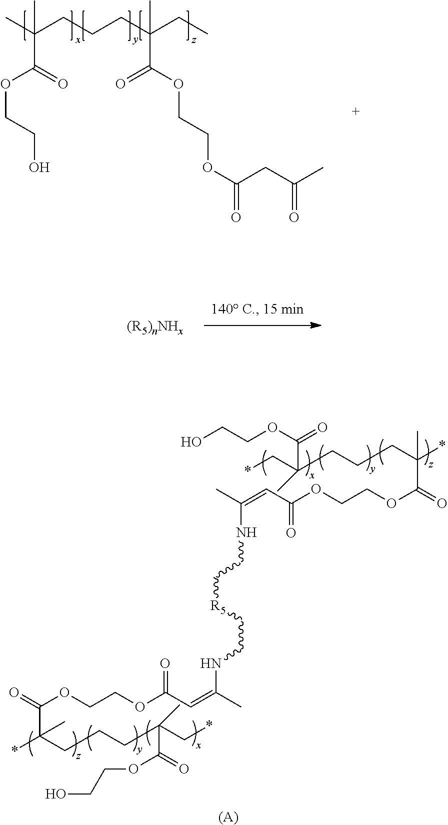

The vitrimers and random terpolymers of the present invention can be produced as films, sheets, foams, particles, granules, beads, rods, plates, strips, stems, tubes, etc. via any process known to those skilled in the art. By way of example, extrusion, casting, compression molding can be used. These elemental components based on the terpolymers and/or vitrimers of the present invention, are easy to store, transport and handle.

The components can be subjected to heat and/or mechanical constraint through blending, extrusion, molding (injection or extrusion), blow-molding, or thermoforming to form an article of manufacture. This transformation can include mixing or agglomeration with one or more additional components chosen from: one or more polymers, pigments, dyes, fillers, plasticizers, fibers, flame retardants, antioxidants, lubricants.

C. Articles of Manufacture

The random terpolymers and/or vitrimers of the present invention can be used in all types of applications and articles of manufacture. Non-limiting examples of the types of applications that the materials of the present invention can be used in include motor vehicles, airplanes, boats, aeronautical construction or equipment or material, electronics, sports equipment, construction equipment and/or materials, printing, packaging, biomedical, and cosmetics. Non-limiting examples of articles of manufacture can include leak tight seals, thermal or acoustic insulators, tires, cables, sheaths, footwear soles, packagings, coatings (paints, films, cosmetic products), patches (cosmetic or dermopharmaceutical), furniture, foams, systems for trapping and releasing active agents, dressings, elastic clamp collars, vacuum pipes, pipes and flexible tubing for the transportation of fluids. Examples of packaging materials include films and/or pouches, especially for applications such as food and/or beverage packaging applications, for health care applications, and/or pharmaceutical applications, and/or medical or biomedical applications. The materials can be in direct contact with an item intended for human or animal use, such as for example a beverage, a food item, a medicine, an implant, a patch or another item for nutritional and/or medical or biomedical use.

The articles of manufacture can exhibit good resistance to tearing and/or to fatigue. The articles of manufacture can include rheological additives or additives for adhesives and hot-melt adhesives. In these applications, the materials according to the invention can be used as such or in single-phase or multiphase mixtures with one or more compounds such as petroleum fractions, solvents, inorganic and organic fillers, plasticizers, tackifying resins, antioxidants, pigments and/or dyes, for example in emulsions, suspensions or solutions.

In an embodiment, an article based on the terpolymers or vitrimers of the present invention can be manufactured by molding, filament winding, continuous molding or film-insert molding, infusion, pultrusion, RTM (resin transfer molding), RIM (reaction-injection molding), 3D printing, or any other method known to those skilled in the art. The means for manufacturing such an article are well known to those skilled in the art. In some embodiments, the terpolymers or vitrimers of the present invention and/or other ingredients can be mixed and introduced into a mold and the temperature raised.

Films that include the terpolymers and/or vitrimers of the present invention can have various thicknesses. For example, films can be from 1 micrometer to 1 mm thick. Multilayer films of the present invention can be produced by co-extrusion or other bonding methodology.

In some embodiments, the vitrimers of the present invention, on account of their particular composition, can be transformed, repaired, and/or recycled by raising the temperature of the article. Below the glass transition (Tg) temperature, the vitrimers are vitreous-like and/or have the behavior of a rigid solid body. Above the Tg temperature (or Tm for semi-crystalline polymers), the vitrimers become flowable and moldable. Below the Tg or the solidification temperature, in case of semi-crystalline materials, the material behaves like a hard glassy solid, whereas above, the material is soft and rubber like. The other temperature of importance is related to the exchange reactions of the vitrimer network called the topology freezing temperature (Tv). Until exchange reactions become fast enough, the network is set, and the topology cannot change. The convention is to place Tv at the solid to liquid transition point where a viscosity of 10¹² Pa·s is reached. The vitrimer will first behave like a glassy solid below Tg in case of amorphous materials, then like an elastomer above Tg, and finally, when Tv is reached, the viscosity will decline following the Arrhenius law because viscosity is predominantly controlled by the exchange reactions. For semi-crystalline polymers, also the melting temperature (Tm) and the crystallization temperature (Tc) has to be considered. For sufficiently crystalline polymers (crystalline network leading to elastic network response), Tm/Tc will have a similar influence as Tg, below which the topology is frozen due to the physical connections provided by the crystals inhibiting flow and therefore the ability to measure Tv.

Transforming at least one article made from a vitrimer of the present invention can include application to the article of a mechanical constraint at a temperature (T) above the Tm of the material. The mechanical constraint and temperature are selected to enable transformation within a time that is compatible with industrial application of the process. By way of example, a transformation can include applying a mechanical constraint at a temperature (T) above the Tm of the material of which the article is composed, and then cooling to room temperature, optionally with application of at least one mechanical constraint. By way of example, an article of manufacture such as a strip of material can be subjected to a twisting action. In another example, pressure can be applied using a plate or a mold onto one or more faces of an article of the invention. Pressure can also be exerted in parallel onto two articles made of material in contact with each other so as to bring about bonding of these articles. In yet another example, a pattern can be stamped in a plate or sheet made of material of the invention. The mechanical constraint may also consist of a plurality of separate constraints, of identical or different nature, applied simultaneously or successively to all or part of the article or in a localized manner. Raising of the temperature of the article or manufacture or of any terpolymer or vitrimer of the present invention can be performed by any known means such as heating by conduction, convection, induction, spot heating, infrared, microwave or radiant heating. The means for bringing about an increase in temperature can include an oven, a microwave oven, a heating resistance, a flame, an exothermic chemical reaction, a laser beam, a hot iron, a hot-air gun, an ultra-sonication tank, a heating punch, etc. In some embodiments, application of a sufficient temperature and a mechanical constraint to an article of manufacture that includes a vitrimer of the present invention, a crack or damage caused in a component formed from the material or in a coating based on the material can be repaired.

In some embodiments, an article made of vitrimer material of the invention may also be recycled, for example, by direct treatment of the article or by size reduction. For example, the broken or damaged article of manufacture can be repaired by means of a transformation process as described above and can thus regain its prior working function or another function. In another example, the article of manufacture can be reduced to particles by application of mechanical grinding, and the particles thus obtained can then be used in a process for manufacturing an article. In some embodiments, the reduced particles can be simultaneously subjected to a raising of temperature and a mechanical constraint; allowing them to be transformed into an article. The mechanical constraint that allows the transformation of particles into an article can include compression molding, blending or extrusion. Thus, molded articles can be made from the recycled material that includes the terpolymers and/or vitrimers of the present invention.

In some embodiments, transforming the components or articles of manufacture can be performed by a final user without chemical equipment (no toxicity or expiry date or VOC, and no weighing out of reagents).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### High Pressure Copolymerization

A continuous stirred autoclave reactor was used to produce the material at an average of 0.6 kg-LDPE/h, operated at 180 to 220° C., pressure of 2000 barg (˜200 MPa), and ethylene flow rate of 4 kg/h with a single monomer and peroxide injection. Total volume was 110 ml, effective volume was 99 ml. Table 1 lists the polymerization conditions and results.

Raw Materials Used
Ethylene: purity >99.9%—Oxygen<5 ppm.
2-(Methacryloyloxy) ethyl acetoacetate (AAEM): purity about 95%.
Isopropanol: purity>99%.

Polymerization Parameters:
Pressure: 2000 bars (200 MPa).
Wall temperature: 200° C.-220° C.
Ethylene flow rate was fixed at around 4 kg/h (residence time ˜45 s).
The impeller velocity was fixed at 1540 rpm.
Peroxide: t-butyl peroxypivalate (Luperox® 11M75, Arkema).
Temperature of polymerization: 180° C.-220° C.
Comonomer flow: 0.05 to 0.4 mol. % of AAEM in the ethylene feed.

TABLE 1

| | | Pres- | | Conver- | |
|---|---|---|---|---|---|
| | | sure | Temp | sion | MFR |
| Run | Polymers | MPa | ° C. | % | g/10 min |
| 1 | Ethylene with 0.05 mol % | 200 | 180 | 8.46 | 0.03 |
| | AAEM in the feed | | | | |
| 2 | Ethylene with 0.05 mol % | 200 | 200 | 10.13 | 0.18 |
| | AAEM in the feed | | | | |
| 3 | Ethylene with 0.1 mol % | 200 | 180 | 8.09 | 0.05 |
| | AAEM in the feed | | | | |
| 4 | Ethylene with 0.1 mol % | 200 | 200 | 10.88 | 0.72 |
| | AAEM in the feed | | | | |
| 5 | Ethylene with 0.2 mol % | 200 | 180 | 9.72 | 0.28 |
| | AAEM in the feed | | | | |
| 6 | Ethylene with 0.2 mol % | 200 | 200 | 11.66 | 2.12 |
| | AAEM in the feed | | | | |
| 7 | Ethylene with 0.4 mol % | 200 | 180 | 9.97 | 0.52 |
| | AAEM in the feed | | | | |
| 8 | Ethylene with 0.4 mol % | 200 | 200 | 12.38 | 2.85 |
| | AAEM in the feed | | | | |

During the reaction, a portion of the ACAC hydrolysed to form HEMA in situ, which reacted with the remaining olefin to form the terpolymer. Table 2 lists the amount of HEMA generated in situ due to the hydrolysis of ACAC.

TABLE 2

| | AAEM Feed | Temp. | MFR | HEMA | ACAC | Combined |
|---|---|---|---|---|---|---|
| Entry | (mol %) | (° C.) | (g/10 min) | (mol %) | (mol %) | (mol %) |
| 1 | 0.05 | 180 | 0.03 | 0.37 | 0.15 | 0.53 |
| 2 | 0.1 | 180 | 0.05 | 0.4 | 0.45 | 0.85 |
| 3 | 0.2 | 180 | 0.28 | 0.5 | 1.1 | 1.6 |
| 4 | 0.4 | 180 | 0.52 | 0.63 | 2.73 | 3.36 |
| 5 | 0.05 | 200 | 0.18 | 0.17 | 0.12 | 0.29 |
| 6 | 0.1 | 200 | 0.72 | 0.2 | 0.38 | 0.58 |
| 7 | 0.2 | 200 | 2.12 | 0.23 | 1.11 | 1.34 |
| 8 | 0.4 | 200 | 2.85 | 0.62 | 2.4 | 3.02 |

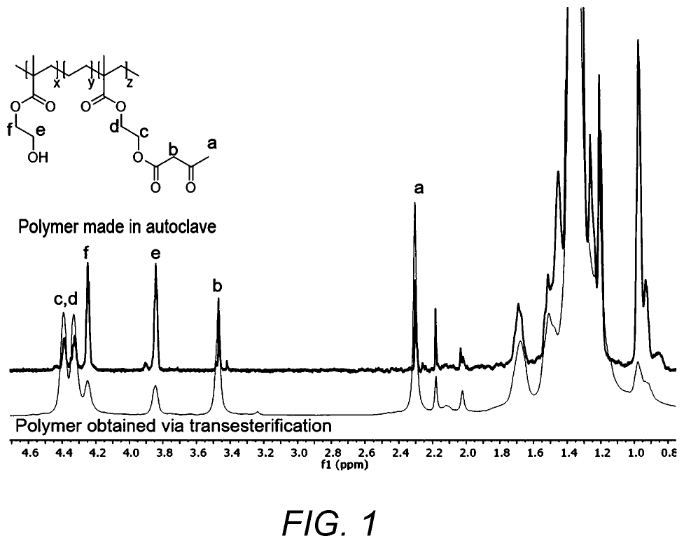

The presence of HEMA was confirmed by high temperature proton nuclear magnetic resonance (HT-′H-NMR) at 100° C. by comparing the spectra to PACHE made through transesterification of a PE-HEMA as shown in reaction scheme (B). FIG. 1 depicts the HT-¹H-NMR of the compounds made using the two different methodology, where the top spectrum is the terpolymer and the bottom spectra the PACHE made through conventional transesterification reactions to produce vitrimer material of the present invention. The transesterification reaction is shown in scheme (B) and the ingredients are listed in Table 3. The transesterification of PE-HEMA was carried out in solution, by first dissolving PE-HEMA polymers with varying amounts of HEMA in toluene, then adding methyl acetoacetate and 4-(dimethylamino)pyridine (DMAP), which was used as a transesterification catalyst. The reaction was carried out under atmospheric pressure to ensure that the developing methanol could evaporate. The polymers could be easily recovered via precipitation. By using PE-HEMA polymers with different amounts of HEMA, PACHE polymers with varying amounts of ACAC were be obtained. Three grades of PE-HEMA were used, obtaining a maximum degree of substitution of 67% (determined via nuclear magnetic resonance (NMR)).

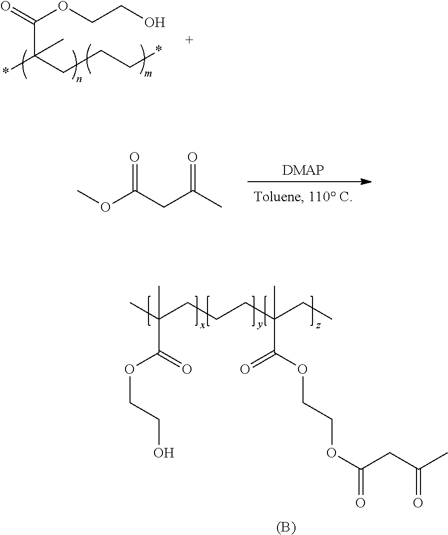

TABLE 3

| | HEMA cont. | Polymer | Toluene | | | t | Func. |
|---|---|---|---|---|---|---|---|
| Entry | (Mol %) | mass (g) | (ml) | ACAC | Cat. | (min) | (NMR) |
| 1 | 16.5 | 8 | 160 | 10 EQ | DMAP, 1 EQ | 420 | 67 |
| 2 | 16.5 | 8 | 160 | 10 EQ | CsF, 0.1 EQ | 1320 | 64 |
| 3 | 1.65 | 16.1 | 160 | 10 EQ | DMAP, 1 EQ | 240 | 58 |
| 4 | 12.4 | 40 | 530 | 5 EQ | DMAP, 1 EQ | 240 | 54 |
| 5 | 7.5 | 30 | 400 | 5 EQ | DMAP, 1 EQ | 240 | 53 |

As shown in the NMR spectra, the methodology of transesterification does not produce polymers with complete functionalization. Thus, the high-pressure polymerization methodology provides more efficient and highly functionalized polymers.

### Example 2

### Preparation of PACHE Vinylogous Urethane Polyolefins

PACHE (polymeric unit “A” described above where R₁ is CH₃, and R₂, R₃, and R₄ are H) was reacted with linking (L) material of XYDIA, (structure III, where R₆ and R₇ are CH₂, and a and b are equal to 1), using the following general procedure to produce PACHE vinylogous urethane polyolefins and PACHE vitrimers of the present invention. The polymer (PACHE) was melted at 140° C. inside a Haake™ PolyLab™ compounding machine until the observed torque was constant. Then, the machine was opened, and 0.55 equivalents of XYDIA (with respect to the ACAC groups in the PACHE) was added slowly using a syringe. Then, the machine was closed and allowed to react for 15 min or until the observed torque was constant. The screws were stopped, and the machine opened and the vitrimer material of the present invention was removed and processed into a film. Table 4 lists an overview of the prepare materials.

TABLE 4

| | | ACAC (mol %) | HEMA (mol %) | Type | EQ |
|---|---|---|---|---|---|
| Entry | Material | In polymer | In polymer | of Amine | amine |
| 1 | PACHE | 0.12 | 0.53 | XYDIA | 0.55 |
| 2 | PACHE | 0.34 | 0.93 | XYDIA | 0.55 |
| 3 | PACHE | 0.66 | 1.34 | XYDIA | 0.55 |
| 4 | PACHE | 0.94 | 1.50 | XYDIA | 0.55 |

### Example 3

### Characterization of Vitrimers of the Present Invention

The vitrimers from Example 2 were made into films using compression molding methodology. The vitrimer material was placed in a mold and compressed at 140° C. to 160° C. at 2000 kN to a thickness of 1 to 1.2 mm and tested using dynamic mechanical thermal analysis (DMTA) and rheology testing.

DMTA. Rectangular samples suitable for DMTA were cut to dimension of 3×5×0.5 mm (length×width×thickness). Samples were measured on a TA Instruments Q800 (TA Instruments, USA) in tensile mode. The storage modulus (E′) and loss modulus (E″) were monitored while screening the samples during a temperature sweep from −100 to 200° C. at 3 K/min. An oscillation frequency of 1 Hz with an oscillation amplitude of 10 μm were applied.

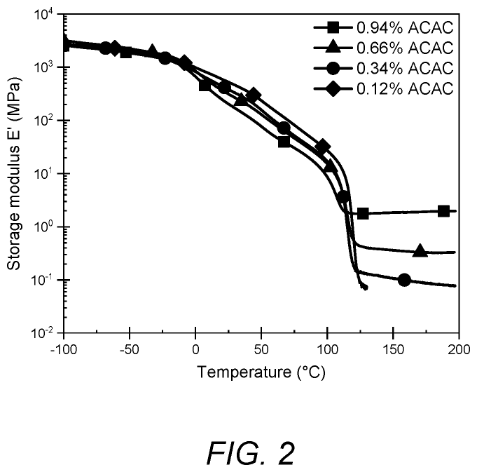

Results. DMTA measurement of PACHE vinylogous urethane polyolefins with different contents of ACAC. FIG. 2 shows DMTA graphs for PACHE vitrimers (Entries 1˜4 of Example 2). The curves are named according to the ACAC content of the parent polymer. Entry 1 (square monikers) had 0.12 mol % ACAC, entry 2 (circle monikers) had 0.34 mol. % ACAC, and entry 3 (diamond monikers) had 0.66 mol. % ACAC, and entry 4 (rectangle monikers) had 94 mol. % ACAC. From the curves it is apparent that 0.12 mol. % of ACAC within the polymer was not sufficient to obtain a fully cross-linked polymer system that provided a rubber plateau after melting of the crystalline regions above about 120° C. The material with 0.34 mol. % of ACAC retained a modulus after melting, revealing the characteristic rubber plateau for semi-crystalline vitrimers Further increasing the ACAC content increased the cross-link density, which in turn raised the observed modulus during DMTA analysis.

Rheology. Samples for rheology were prepared via compression molding to obtain disk shaped specimens (diameter 25 mm, thickness 1 mm). Samples were measured using a TA Instruments DHR-2, equipped with a parallel plate geometry. Samples were measured with a frequency sweep from 100-0.01 rad/s using a strain amplitude of 0.4% at a temperature of 150° C.

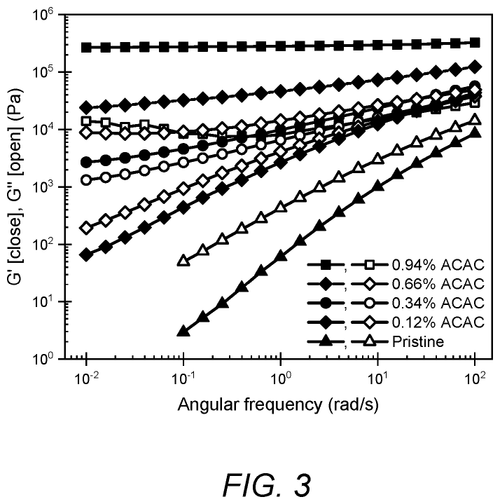

Frequency sweep of PACHE vinylogous urethane polyolefins with different contents of ACAC: Referring to FIG. 3, the crosslinking of the material was analyzed. The curve of the pristine sample (no crosslinking, square monikers) corresponded to the comparison of PACHE copolymer with 0.34 mol. % of ACAC (and no XYDIA) and was taken as a general representation of a low-density polyolefin. Even though cross-linking of the 0.12 mol. % of ACAC (entry 1) containing polymer was not enough to observe a rubber plateau modulus of the vitrimer during DMTA, partial cross-linking and chain extension was determined to have occurred, as the rheology of this sample (square filled and non-filled monikers) was severely altered in comparison to the comparison polymer (black line). This was apparent from the increased moduli and observed crossover frequency where G′>G″, which was not observed for the comparison polymer in the melt within the same measurement range. From the data of Entry 2 with 0.34 mol % of ACAC (filled and unfilled triangle monikers), a solid character over the entire frequency range, with G′>G″ within the available measurement range was observed, although the material was not fully cross-linked, because G′ was still dependent on the time scale (frequency dependent). Raising the cross-link density (Entry 3), resulted in a further increased storage modulus, but a frequency dependence persisted. Entry 4, having 0.94 mol. % of ACAC (filled and unfilled diamond monikers) exhibited the expected rheology for a fully cross-linked polymer, with G′>G″ over the measured frequency range and a completely frequency independent storage modulus G′.

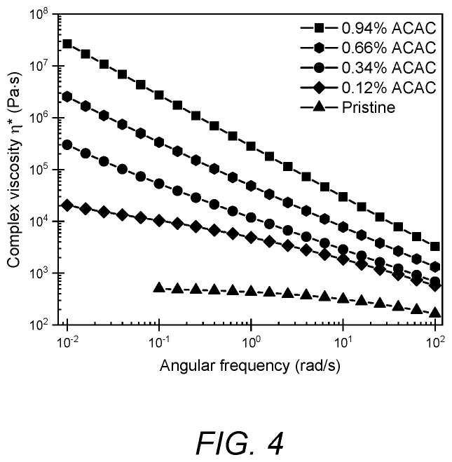

Complex viscosity as function of frequency of PACHE vinylogous urethane copolymers with different contents of ACAC: The complex viscosity determined during rheology experiments (See, FIG. 4) provided a similar picture as was observed from the storage and loss moduli. Usually a constant at low shear rates/low frequency for polymer melts (known as zero shear), the melt viscosity increased linearly for the cross-linked species with greater increases for higher cross-link densities. No zero shear was observed or expected for the cross-linked materials within the available measurement range.

Determination of crosslinking. The presence of crosslinking in the polymers was determined using gel fraction methodology, based on the solubility of the polymers in xylene at 100° C. as compared to the pristine non-crosslinked polymer, which is fully soluble in xylene.

Gel Fraction Method. Extruded pieces (mass of each sample approximately 190 mg) were first placed in a 50 mL vial, 10 mL of xylene was added to the vial, the vial closed, heated to 100° C., and kept for 24 h. After cooling to room temperature, the liquid was removed with a syringe and the solid residue washed at least three times with methanol. The samples were dried in a vacuum oven (80° C.) until the weight was constant. The gel fraction was determined according to the equation (1) and the average from at least 6 specimens. The results are listed in Table 5.

Gel fraction (%)=(m_{final}/mᵢₙᵢₜᵢₐₗ)*100 (1)

TABLE 5

| | | Gel content |
|---|---|---|
| Entry | Sample | (in %) |
| 1 | PACHE with 0.66% ACAC | 0% |
| 2 | PACHE with 0.66% ACAC and 0.55 EQ XYDIA | 43.1 ± 1.2% |
| 3 | PACHE with 0.94% ACAC | 0% |
| 4 | PACHE with 0.94% ACAC and 0.55 EQ XYDIA | 65.3 ± 4.4% |

Entries 1 and 3 represent the pristine polymer, which were fully soluble in xylene. Entries 2 and 4 represent vitrimers of the present invention. When the amount of crosslinker was increased, the gel fraction went from 0% to 43.1±1.2% for vitrimers with 1.9 crosslinks/chain and 65.3±4.4% for vitrimers with 2.6 crosslinks/chain.

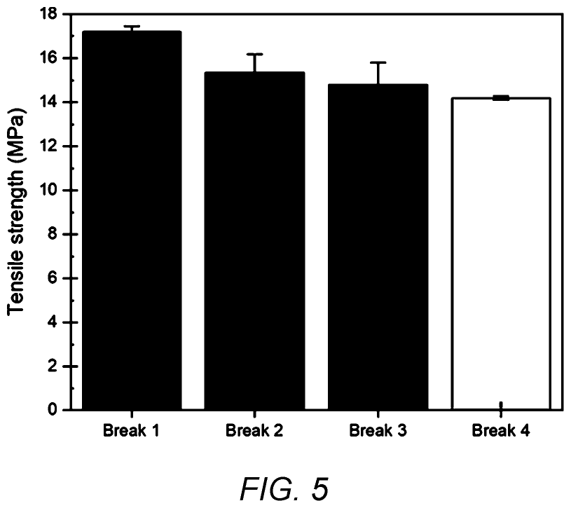

Recyclability. Recyclability was illustrated by reprocessing experiments using injection molded dog bones made from the vitrimers of the present invention. Tensile performance of the injection molded dog bones was measured. Tensile tests were performed with a Zwick type Z020 tensile tester equipped with a 1 kN load cell. The tests were performed on injection molded dog bones with dimensions of 75 mm×4 mm×2 mm. A grip-to-grip separation of 30 mm was used. The samples were pre-stressed to 0.5 N and then loaded with a constant cross-head speed of 50 mm·min⁻¹. The maximum tensile strength of extruded dog bones was determined. Then, the tested (broken) dog bones were employed for successive extrusion steps to obtain recycled dog bones, which were subsequently tested in their tensile strength. This process was repeated three times. FIG. 5 shows average results (from quadruplets) of tensile tests on PACHE with 0.94% ACAC and 0.55 EQ XYDIA processed 1, 2, 3 and 4 times. From the data, it was determined that the vitrimers are recyclable minimal loss of tensile strength was observed.

Adaptability of the vitrimers of the present invention was apparent from being able to compression mold defect free rectangular disks and by the ability to reprocess these disks if necessary.

Although embodiments or aspects of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A random terpolymer comprising a random distribution of:
a hydrocarbon unit (A) having the formula 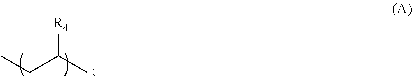
an acetoacetate (ACAC) terminated unit (B) having the formula 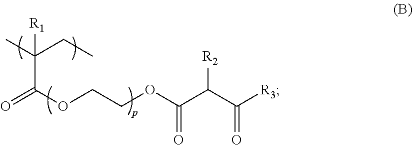
and
a hydroxy terminated unit (C) having the formula 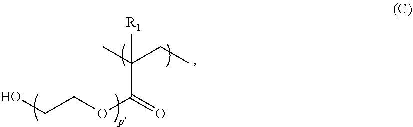
where R₁ and R₂ are each independently hydrogen (H) or a C₁₋₅ alkyl group, R₃ is a C₁₋₁₀ alkyl group, R₄ is a H or a C₁₋₅ alkyl group, p is 1 to 9, and p′ is 1 to 9,
wherein the hydrocarbon unit (A), the ACAC terminated unit (B), and the hydroxy terminated unit (C) are comprised in the random terpolymer;
wherein the random terpolymer is produced by a process comprising contacting a reactant mixture comprising a C₂₋₅ olefinic monomer and an acetoacetate terminated monomer with a polymerization initiator and a hydroxy-terminated monomer, and
reacting the hydroxy-terminated monomer randomly with the hydrocarbon C₂₋₅ olefinic monomer and the acetoacetate terminated monomer at a temperature of 100° C. to 350° C. and a pressure of 180 MPa to 350 MPa;
wherein concentration of the acetoacetate monomer in the reactant mixture is less than 10 mol. %.

2. The random terpolymer of claim 1, wherein R₁ and R₂ are each independently hydrogen (H) or methyl (CH₃).

3. The random terpolymer of claim 1, wherein the random terpolymer includes less than 10 mol. % of the acetoacetate functionality.

4. The random terpolymer of claim 1, wherein the random terpolymer is the random reaction product of an olefin.

5. The random terpolymer of claim 1, wherein the random terpolymer is insoluble in water.

6. A high-pressure free radical process to produce the terpolymer of claim 1, the process comprising contacting a reactant mixture comprising a C₂₋₅ olefinic monomer and an acetoacetate terminated monomer with a polymerization initiator and a hydroxy-terminated monomer, and
reacting the hydroxy-terminated monomer randomly with the hydrocarbon C₂₋₅ olefinic monomer and the acetoacetate terminated monomer at a temperature of 100° C. to 350° C. and a pressure of 180 MPa to 350 MPa.

7. The process of claim 6, wherein concentration of the acetoacetate monomer in the reactant mixture is less than 1 mol. %.

8. The process of claim 6, wherein the C₂₋₅ olefinic monomer is ethylene, the acetoacetate terminated monomer is 2-(methacryloyloxy)ethyl acetoacetate, and the polymerization initiator is a peroxide material.

9. The process of claim 6, wherein the hydroxy terminated monomer is hydroxyl-ethyl methacrylate.

10. The process of claim 9, wherein the C₂₋₅ olefinic monomer is ethylene, the acetoacetate terminated monomer is 2-(methacryloyloxy)ethyl acetoacetate, and the polymerization initiator is a peroxide material.

11. The process of claim 6, wherein the process is a continuous process.

12. An article of manufacture comprising the random terpolymer of claim 1.

13. A vitrimer material comprising at least two polymeric units (D, D′) and a linking moiety (L) having the formula D-L-D, wherein D, D′ or both can have a random distribution of a hydrocarbon unit (A) having the formula 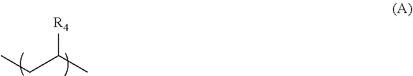
an acetoacetate (ACAC) terminated unit (B) having the formula 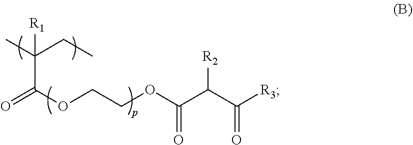
and
a hydroxy terminated unit (C) having the formula 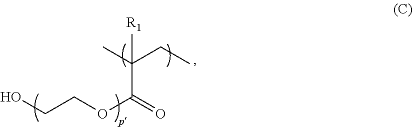
where R₁ and R₂ are each independently hydrogen (H) or a C₁₋₅ alkyl group, R₃ is a C₁₋₁₀ alkyl group, R₄ is a H or a C₁₋₅ alkyl group, p is 1 to 9, and p′ is 1 to 9,
wherein the vitrimer is recyclable.

14. The vitrimer material of claim 13, wherein L is a polyamino group comprising at least two secondary amines.

15. The vitrimer material of claim 14, wherein the polyamino group is 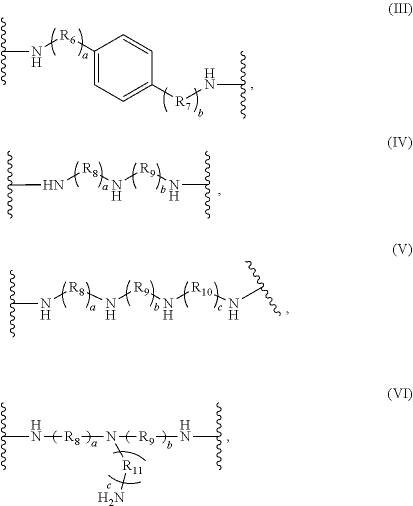
or any combination thereof,
where R₆ and R₇ are each independently an aliphatic group, and R₈, R₉, R₁₀, and R₁₁ are each independently an aliphatic group, or an aromatic group, and a is 1 to 20, b is 1 to 20 and c is 1 to 20.

16. The vitrimer material of claim 13, wherein the polymeric unit D, D′ or both, are derived from a random terpolymer comprising a random distribution of:
a hydrocarbon unit (A) having the formula 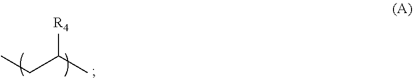
an acetoacetate (ACAC) terminated unit (B) having the formula 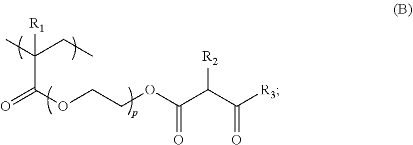
and
a hydroxy terminated unit (C) having the formula 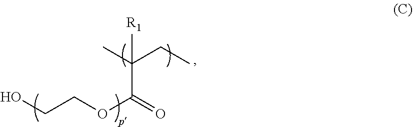
where R₁ and R₂ are each independently hydrogen (H) or a C₁₋₅ alkyl group, R₃ is a C₁₋₁₀ alkyl group, R₄ is a H or a C₁₋₅ alkyl group, p is 1 to 9, and p′ is 1 to 9,
wherein the hydrocarbon unit (A), the ACAC terminated unit (B), and the hydroxy terminated unit (C) are comprised in the random terpolymer;
wherein the random terpolymer is produced by a process comprising contacting a reactant mixture comprising a C₂₋₅ olefinic monomer and an acetoacetate terminated monomer with a polymerization initiator and a hydroxy-terminated monomer, and
reacting the hydroxy-terminated monomer randomly with the hydrocarbon C₂₋₅ olefinic monomer and the acetoacetate terminated monomer at a temperature of 100° C. to 350° C. and a pressure of 180 MPa to 350 MPa;
wherein concentration of the acetoacetate monomer in the reactant mixture is less than 10 mol. %.

17. The vitrimer material of claim 13, wherein the vitrimer comprises a semi-crystalline morphology.

18. A process of producing a vitrimer material of claim 13 using an extruder, the process comprising contacting a reactant mixture comprising a random terpolymer with a polyamino group comprising at least two secondary amines at temperatures from 120° C. to 300° C.,
wherein the random terpolymer comprises a random distribution of:
a hydrocarbon unit (A) having the formula 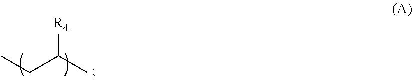
an acetoacetate (ACAC) terminated unit (B) having the formula 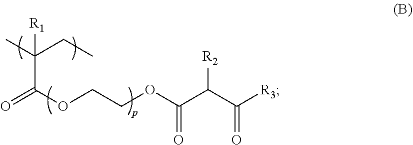
and
a hydroxy terminated unit (C) having the formula 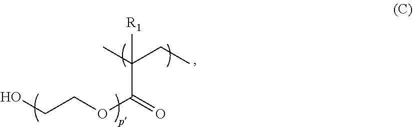
where R₁ and R₂ are each independently hydrogen (H) or a C₁₋₅ alkyl group, R₃ is a C₁₋₁₀ alkyl group, R₄ is a H or a C₁₋₅ alkyl group, p is 1 to 9, and p′ is 1 to 9,
wherein the hydrocarbon unit (A), the ACAC terminated unit (B), and the hydroxy terminated unit (C) are comprised in the random terpolymer;
the process comprising contacting a reactant mixture comprising a C₂₋₅ olefinic monomer and an acetoacetate terminated monomer with a polymerization initiator and a hydroxy-terminated monomer, and
reacting the hydroxy-terminated monomer randomly with the hydrocarbon C₂₋₅ olefinic monomer and the acetoacetate terminated monomer at a temperature of 100° C. to 350° C. and a pressure of 180 MPa to 350 MPa.

19. An article of manufacture comprising the vitrimer material of claim 13.

20. (canceled)

21. An article of manufacture comprising the vitrimer material of claim 14.
